(19) United States
(12) Patent Application Publication
(10) Pub. No.: US 2013/0228635 A1
(43) Pub. Date: Sep. 5, 2013

(54) TURBOJET ENGINE NACELLE

(71) Applicant: AIRCELLE, GONFREVILLE L'ORCHER (FR)

(72) Inventor: Pierre CARUEL, Le Havre (FR)

(21) Appl. No.: 13/663,652

(22) Filed: Oct. 30, 2012

Related U.S. Application Data
(63) Continuation of application No. PCT/FR2011/050924, filed on Apr. 21, 2011.

(30) Foreign Application Priority Data
Apr. 30, 2010 (FR) 10/53373

(51) Int. Cl. F02K 1/72

(52) U.S. Cl. CPC F02K 1/72
USPC 239/11; 239/265.33

(57) ABSTRACT

A bypass turbojet engine nacelle equipped with a thrust reverser device is provided that includes a cowl with translational mobility and a diversion means supported by a front frame upstream of the cowl. A variable-geometry jet pipe nozzle is mounted at a downstream end of the cowl and is translatable in a direction substantially parallel to a longitudinal axis of the nacelle towards at least one position that causes a variation in its cross-section. At least part of the front frame, the diversion means, and the jet pipe nozzle form an assembly having translational mobility in a direction substantially parallel to a longitudinal axis of the nacelle in a downstream direction of the nacelle towards a position that causes a variation in the cross-section of the jet pipe nozzle, the cowl being in the closed position during that movement of said assembly.

### CROSS-REFERENCE TO RELATED APPLICATIONS

This application is a continuation of International Application No. PCT/FR2011/050924 filed on Apr. 21, 2011, which claims the benefit of FR 10/53373, filed on Apr. 30, 2010. The disclosures of the above applications are incorporated herein by reference.

### FIELD

The present disclosure relates to a turbojet engine nacelle comprising a variable jet pipe nozzle geometry and also to a method implemented by such a nacelle.

### BACKGROUND

The statements in this section merely provide background information related to the present disclosure and may not constitute prior art.

An airplane is moved by several turbojet engines each housed in a nacelle also housing a set of related actuating devices connected to its operation and performing various functions when the turbojet engine is running or stopped.

These related actuating devices in particular comprise a thrust reverser device.

More specifically, a nacelle generally has a tubular structure comprising an air intake upstream of the turbojet engine, a middle section designed to surround a fan of the turbojet engine, a downstream section housing the thrust reverser means and designed to surround the turbojet engine combustion chamber, and generally ends with a jet pipe nozzle located downstream of the turbojet engine.

This nacelle is designed to house a bypass turbojet engine capable of generating, through the rotating fan blades, a flow of hot air, coming from the combustion chamber of the turbojet engine, and a flow of cold air that circulates outside the turbojet engine through an annular tunnel.

The thrust reverser device is designed, during landing of the aircraft, to improve the braking capacity thereof by orienting at least part of the thrust generated by the turbojet engine forward.

In that phase, the thrust reverser device obstructs the cold air flow tunnel and orients the latter toward the front of the nacelle, thereby generating a counter-thrust that is added to the braking of the aircraft's wheels.

The means used to perform this reorientation of the cold air flow vary depending on the type of reverser.

However, in all cases, the structure of a reverser comprises a movable cowl that can be moved on the one hand between a deployed position, in which it opens a passage in the nacelle designed for the deflected air flow, and on the other hand a retracted position, in which it closes the passage.

This cowl may perform a cascade function, or simply serve to activate other cascade means.

In the case of a cascade vane thrust reverser, the flow of air is reoriented by cascade vanes, associated with reverser flaps, the cowl performing only a sliding function aiming to expose or cover the cascade vanes.

The reverser flaps form blocking doors that may be activated by sliding of the cowl, causing closing of the tunnel downstream of the grids, so as to optimize the reorientation of the flow of cold air.

Furthermore, aside from its thrust reversal function, the sliding cowl belongs to the rear section and has a downstream side forming the jet pipe nozzle aiming to channel the discharge of the flows of air.

This nozzle provides the power necessary for propulsion by imparting a speed to the exhaust stream and modulates the thrust by varying the outlet area thereof in response to variations of the adjustment of the power of the engine and flight conditions.

This nozzle is associated with an actuating system that may or may not be independent from that of the cowl, making it possible to vary and optimize the section thereof as a function of the current flight phase of the aircraft.

One recurring problem in this type of thrust reverser is the limited space dedicated to the flow passage section of the tunnel.

### SUMMARY

The present disclosure includes a nacelle in which the space available for the cascade vanes in the thrust reverser device is improved, along with the space available for the cold flow tunnel.

To that end, the present disclosure relates to a bypass turbojet engine nacelle equipped with a thrust reverser device comprising a cowl, diversion means supported by a front frame upstream of the cowl, said cowl having translational mobility in a direction substantially parallel to a longitudinal axis of the nacelle and being able alternately to move from a closed position in which it ensures the aerodynamic continuity of the nacelle and covers the diversion means, into an open position in which it opens up a passage in the nacelle and uncovers the diversion means, said cowl being extended by at least one variable-geometry jet pipe nozzle mounted at a downstream end of said cowl, remarkable in that at least part of the front frame, the diversion means and the jet pipe nozzle have translational mobility in a direction substantially parallel to a longitudinal axis of the nacelle with respect to the cowl towards a position that causes a variation in the cross-section of the jet pipe nozzle.

More particularly, at least part of the front frame, the diversion means and jet pipe nozzle form an assembly having translational mobility in a direction substantially parallel to a longitudinal axis of the nacelle in the downstream direction of the nacelle, reversibly, toward a position causing a variation in the cross-section of the jet pipe nozzle, the cowl being in its closed position during the movement of said assembly. Owing to the present disclosure, in which a thrust reverser device is proposed with two independent moving assemblies, i.e. a jet pipe nozzle, a front frame and diversion means movable independently from the cowl, the increase of the passage section of the flow in the tunnel is favored.

According to particular forms of the invention, a device according to the present disclosure may comprise one or more of the following features, considered alone or in technically possible combinations:
the front frame comprises a support element for the diversion means, said support element being translatable with the jet pipe nozzle when it is moved toward a position causing a variation in the cross-section of the jet pipe nozzle;
the diversion means are extended downstream by a rear frame secured to the jet pipe nozzle, said rear frame being translatable with the jet pipe nozzle when it is moved toward a position causing a variation in the section of the jet pipe nozzle;
the jet pipe nozzle is suitable for sliding inside the cowl;
the jet pipe nozzle comprises first and second covering panels ensuring covering between the jet pipe nozzle and an outer shroud and an inner shroud of the cowl, respectively;
a rail-guideway assembly is formed between the first covering panel of the jet pipe nozzle and the outer shroud of the cowl;
the nacelle also comprises a middle section upstream of the thrust reverser device, at least the support element of the front frame and at least part of the diversion means are housed in said middle section;
the diversion means comprise cascade vanes and an upstream extension structure of said vanes suitable for ensuring limited downstream movement of the front frame;
the front frame comprises a front stationary part designed to provide support, through discrete fittings, for the middle section of the nacelle;
the front frame comprises a support surface sliding between the middle section and the front frame;
the nacelle also comprises means for actuating the cowl placed between two reverser flaps, under the surface producing the pressure barrier for the cold air tunnels;
the nacelle also comprises means for actuating the jet pipe nozzle, cascade vanes and at least part of the front frame placed between two adjacent cascade vanes.

The invention also relates to a method implemented with the nacelle as described above in which part of the front frame, the diversion means and the jet pipe nozzle are translated in a direction substantially parallel to a longitudinal axis of the nacelle in relation to the cowl toward a position causing a variation in the cross-section of the jet pipe nozzle.

### DRAWINGS

Other features, aims and advantages of the present invention will appear upon reading the following detailed description, according to embodiments provided as non-limiting examples, and in reference to the appended drawings, in which:

FIG. 1 is a partial cross-sectional view of a first embodiment of the nacelle according to the present disclosure;

FIG. 2 is a partial cross-sectional view of a second embodiment of a nacelle according to the present disclosure;

FIGS. 3a to 3c are respective cross-sectional views of a nacelle according to FIG. 1, wherein the jet nozzle respectively has a nominal, increased, and reversed jet section;

FIG. 4 shows a perspective view of air flow diversion means of a nacelle according to FIG. 1; and

FIGS. 5 to 7 illustrate cross-sectional views of a nacelle according to FIG. 1, illustrating the actuating means in positions for which the jet pipe nozzle respectively has an increased, nominal, and reversed jet section.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A nacelle is designed to form a tubular housing for a bypass turbojet engine and serves to channel the flows of air that it generates through fan blades, i.e. a flow of hot air passing through the combustion chamber and a flow of cold air circulating outside the turbojet engine.

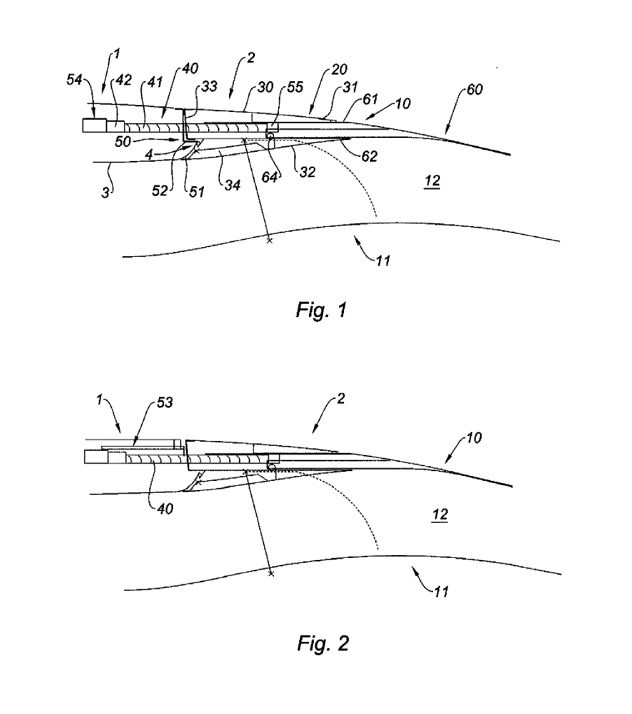

The nacelle generally has a structure comprising an upstream section forming an air intake, a middle section 1 surrounding the fan of the turbojet engine, and a downstream section surrounding the turbojet engine, designated by general reference 2 in FIG. 1.

In reference to this figure, the downstream section 2 comprises an outer structure 10 including a thrust reverser device 20 and an inner engine fairing structure 11 defining, with the outer structure 10, a tunnel 12 designed for the circulation of a cold flow in the case of a bypass turbojet engine as presented here.

The thrust reverser device 20 comprises a moving cowl 30 translatably mounted in a direction substantially parallel to a longitudinal axis of the nacelle capable of alternating between a closed position in which it ensures the aerodynamic continuity of the nacelle and covers the diversion means 40, into an open position in which it opens a passage in the nacelle and uncovers the diversion means 40, said cowl 30 also being extended by at least one jet pipe nozzle section 60 aiming to channel the discharge of the cold flow, mounted at a downstream end of said cowl 30.

This jet pipe nozzle 60 may supplement a primary jet pipe nozzle channeling the hot flow and is called secondary jet pipe nozzle.

As illustrated in FIG. 1, the downstream section 2 also comprises a front frame 50 extended downstream by the cowl 30.

The front frame 50 comprises an element (not shown) called a conical shell designed to ensure support between the front frame 50 and the fan case 3 and middle section 1 of the nacelle, respectively.

This shell may enable fire resistance.

The front frame 50 also comprises a diversion edge element 51 ensuring the aerodynamic line with the fan case 3 during reversed jet operation.

At least these two elements form the front stationary part of the front frame 50.

In one non-limiting example of the present disclosure, the upstream portion of this front stationary portion comprises traditional fastening means (not shown) for fastening to the fan case 3, of the blade connection type with an upside down U-shaped cross-section allowing housing in a groove formed by the fan case 3.

The front stationary portion of the front frame 50 is also designed to provide support, on the one hand for the middle section 1 of the nacelle using discrete fittings 52 placed between the diversion means 40 and, on the other hand, actuating means of the cowl 30, as will be seen later.

A sealing device 4 is also placed at the interface between the diversion edge 51 of the front frame 50 and the upstream portion of the cowl 30.

In reference to FIG. 2, in a second form, the fittings are eliminated between the front stationary portion and the middle section 1 of the nacelle, and they are replaced by support bars 53 extending along the longitudinal axis of the nacelle secured to the diversion means 40 and placed between two elements of the diversion means 40 to serve as sliding support for the middle section.

In reference to FIG. 1, the diversion means 40 comprises a plurality of cascade vanes 41, the front frame 50 also comprises a structural element 54 designed to support the cascade vanes 41 housed, in the retracted position, partially in the thickness of the cowl 30, when the latter is in the closed position, and partially in the thickness of the middle section 1.

The cascade vanes 41 divert the cold flow from the tunnel 12 through the reversal chamber uncovered after downstream translation of the cowl 30.

The support element 54 of the front frame 50 is placed upstream of the vanes 41 in the thickness of the middle section 1.

The cascade vanes 41 supported by this support element 54 are also extended by a rear frame 55 housed inside the thickness of the cowl 30.

The support element 54 as well as the diversion means 41 are attached to a stationary structure (not shown) using rails and guideways connected to the mast of the turbojet engine or the other half-reverser.

The rear frame 55 is fastened upstream of the jet pipe nozzle 60.

In non-limiting examples of the present disclosure, the support element(s) 54 of the front frame 50 and the rear frame(s) 55 are rings or ring sections.

The cowl 30 comprises an outer shroud 31 and an inner shroud 32 that is present in the continuation of the front frame 50.

The outer shroud 31 is connected to the inner shroud 32 using fittings 33 passing through two adjacent cascade vanes 41, as illustrated in FIG. 4.

In its open position in which it opens a passage in the nacelle and uncovers the diversion means 40, the cowl 30 allows the secondary flow of the turbojet engine to at least partially escape, said flow portion being reoriented toward the front of the nacelle 1 by the cascade vanes 41, thereby generating a counter-thrust able to assist the braking of the aircraft.

In order to increase the portion of the secondary flow passing through the vanes 41, the inner shroud 32 of the cowl 30 comprises a plurality of reverser flaps 34, distributed over its circumference and each mounted pivoting by one end around a hinge pin, on the cowl 30 sliding between a retracted position in which the flap 34 closes the opening and ensures the inner aerodynamic continuity of the tunnel 12, and a deployed position in which, in the reverse thrust situation, it at least partially covers the tunnel 12 in order to divert the cold flow toward the vanes 41.

Such an installation may traditionally be done using a set of link rods ending, if necessary, with a spring blade in order to accommodate the various machining allowances and apply a closing force on the flap.

During the direct thrust operation of the turbojet engine, the sliding cowl 30 forms all or part of the downstream section 2 of the nacelle, the flaps 34 then being retracted in the sliding cowl 30, which covers the vane passage 41.

During a phase for varying the cross-section of the jet pipe nozzle 60, the reverser flaps 34 may remain in the retracted position, like the cowl 30.

To reverse the thrust of the turbojet engine, the sliding cowl 30 is moved in the downstream direction into the open position, and the flaps 34 pivot into the position covering the tunnel 12 so as to divert the cold flow toward the vanes 41 and form a reversed flow guided by the vanes 41.

Furthermore, as previously mentioned, the sliding cowl 30 has a downstream side forming the exhaust jet pipe nozzle 60 aiming to channel the discharge of the cold flow, said jet pipe nozzle 60 being partially housed in the thickness of the cowl 30.

The jet pipe nozzle 60 thus comprises, at both ends thereof, first 61 and second 62 covering panels ensuring covering between the jet pipe nozzle 60 and the outer shroud 31 and inner shroud 32, respectively, of the cowl 30.

The first covering panel 61 covers the inner portion of the outer shroud 31 of the cowl 30, in the thickness of the cowl 30.

The second covering panel 62 comprises an upstream acoustic panel partially covering the inner portion of the inner shroud 31 and, more particularly, the inner acoustic panel thereof.

Sealing means 64 are placed between the second covering panel 62 and the inner shroud 32.

The interfaces of the covering panels 61, 62 of the jet pipe nozzle 60 with the outer shroud 31 and the inner shroud 32 of the cowl 30 are parallel to the longitudinal axis of the nacelle.

The optimal section of this exhaust jet pipe nozzle 60 may be adapted as a function of the different flight phases, i.e. the takeoff, ascent, cruising, descent, and landing phases of the aircraft.

The variation of this section, illustrating the variation of the cross-section of cold flow tunnel 10, is done by partially translating the jet pipe nozzle 60.

The jet pipe nozzle can thus be moved into a position varying the cross-section of the jet pipe nozzle 60, i.e. at least one position decreasing the cross-section of the jet pipe nozzle and a position increasing the cross-section of the jet pipe nozzle.

The transition from one position to the other of the jet pipe nozzle 60 is commanded by actuating means dedicated to the jet pipe nozzle 60 capable of activating the movement of the jet pipe nozzle 60 toward a position causing the cross-section of the jet pipe nozzle 60 to vary.

Other actuating means can activate the reversible movement of the cowl 30 between its different positions.

In fact, advantageously, the exhaust jet pipe nozzle 60 and the cowl 30 move independently of one another.

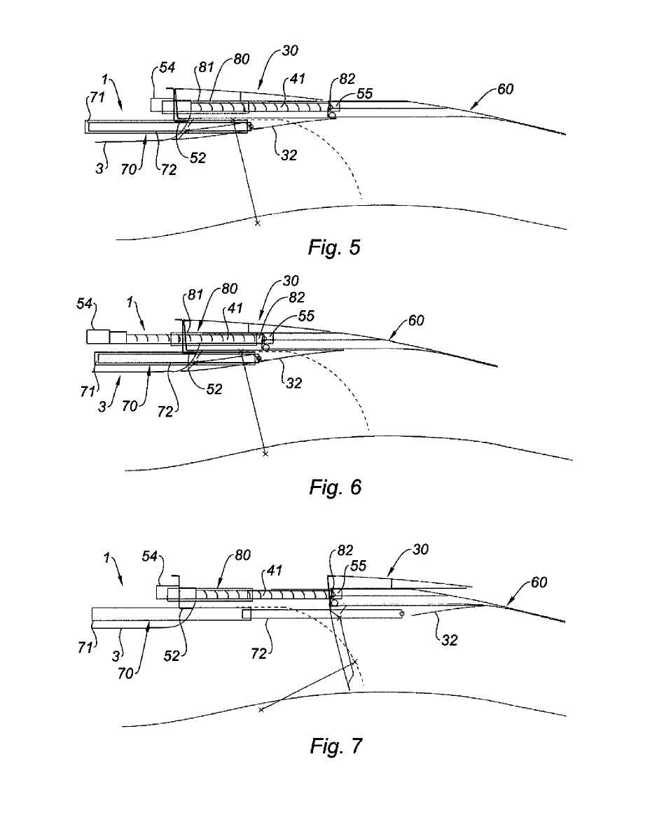

The actuating means mentioned will be described in more detail hereafter in reference to FIGS. 5 to 7.

According to the present disclosure, at least part of the front frame 50, the cascade vanes 41 and the jet pipe nozzle 60 forming a first moving assembly can be axially translated along the longitudinal axis of the nacelle in relation to the cowl 30 in a movement toward a position varying the cross-section of the jet pipe nozzle 60.

More specifically, the support element 54 of the vanes 41, the cascade vanes 41 and the rear frame 55 are able, on the one hand, to slide in concert with the jet pipe nozzle 60 between its positions varying the outlet cross-section of the jet pipe nozzle 60 while the cowl 30 remains stationary and, on the other hand, to move away from the cowl 30 when the cowl 30 is moved toward an open position during thrust reversal.

In thrust reversal, a second moving assembly is then translated comprising the reverser flaps 34 and the cowl 30, i.e. the inner shroud 32 and the outer shroud 33, so as to uncover the cascade vanes 41 and pivot the reverser flaps 34 in the tunnel 12.

The interface between the front frame 50, the cascade vanes 41, the middle section 1 and the case 3, making it possible to ensure the described movements, provides an extension structure 42 extending the cascade vanes 41 in the upstream portion thereof and secured to the support element 54.

This extension structure 42 has a generally rectangular cross-section similar to that of the support element 54 of the vanes 41.

The dimensions of the extension structure 42 are adapted to make it possible to place the support element 54 of the front frame 50 upstream of the fittings 52 passing through the cascade vanes 41 when the first moving assembly is moved into a position varying the cross-section of the jet pipe nozzle 60 and, more particularly, toward a position corresponding to an increase of the jet pipe nozzle 60.

In one alternative form, the extension structure 42 may also comprise stop means in order to ensure a reaction of forces between the support element 54 and the stationary part of the front frame 50 beyond a position corresponding to a position of the jet pipe nozzle 60 allocated to a maximum increase in the cross-section of the jet pipe nozzle 60.

The present disclosure, which proposes a first moving assembly comprising the support element 54, the cascade vanes 41, the rear frame 55 and the jet pipe nozzle 60 for the phases varying the cross-section of the jet pipe nozzle, and a second independent moving assembly comprising the cowl 30 during thrust reversal phases, offers many advantages.

Thus, the translation of the diversion means 40 offers the advantage of maximizing the available space for the vanes.

Furthermore, the first moving assembly as previously defined makes it possible to arrange the latter further upstream, which makes it possible to reduce the thickness of the cowl 30 and free space to draw aerodynamic lines that increase the passage section for the flow of air.

An additional space is thus available for the secondary tunnel.

This increase in the passage section reduces the flow speed in the tunnel and the associated aerodynamic losses.

Regarding the movement of the two moving assemblies during the phases for varying the cross-section of the jet pipe nozzle 60 and during thrust reversal phases, two independent actuating systems can be considered or a single actuating system capable of independently performing the movement of the first moving assembly and the second moving assembly, for example such as a telescoping jack.

These actuating means may be any suitable known actuating means comprising at least one hydraulic, pneumatic, or electric linear actuator or motorized ball screw spindles.

The actuating means are illustrated in FIGS. 5 to 7.

Regarding the movement of the cowl 30, at least one actuating jack 70 suitable for reversibly moving the cowl 30 in the downstream direction without driving the jet pipe nozzle 60 or the support element 54 with the vanes 41 is placed under the surface producing the pressure barrier of the tunnel between two reverser flaps 34.

The body 71 of the jack 70 is fastened at an upstream end to the fan case 3 or the stationary portion of the front frame 50, while an inner rod 72 is fastened to the inner shroud 32 of the cowl 30. The body 71 of said actuator overflows into the thickness of the middle section 1 of the nacelle.

Regarding the movements of the first moving assembly, at least one actuating jack 80 suitable for reversibly moving the jet pipe nozzle 60, the support element 54, the vanes 41 in the downstream direction is placed between two adjacent cascade vanes 41.

The body 81 of the cylinder 80 is fastened at an upstream end to a fitting 52 connecting the diversion edge of the front frame 50 to the middle section 1 or directly to the stationary portion of the front frame 50 using a fitting (not shown), while an inner rod 82 is fastened to the rear frame 55.

During thrust reversal phases, the jacks 70, 80 may be deployed at the same speed or with a differential movement and offset kinematics, or ideally the jet pipe nozzle 60 will have been positioned beforehand in its withdrawn position (position corresponding to the phases where thrust reversal may be requested).

In that case alone, the jack 70 must be actuated to command the thrust reversal.

Furthermore, a rail/guideway assembly known by those skilled in the art may be placed between the two moving assemblies, and more particularly between the outer shroud 31 and the first covering panel 61 of the jet pipe nozzle 60, in order to assist the relative sliding thereof.

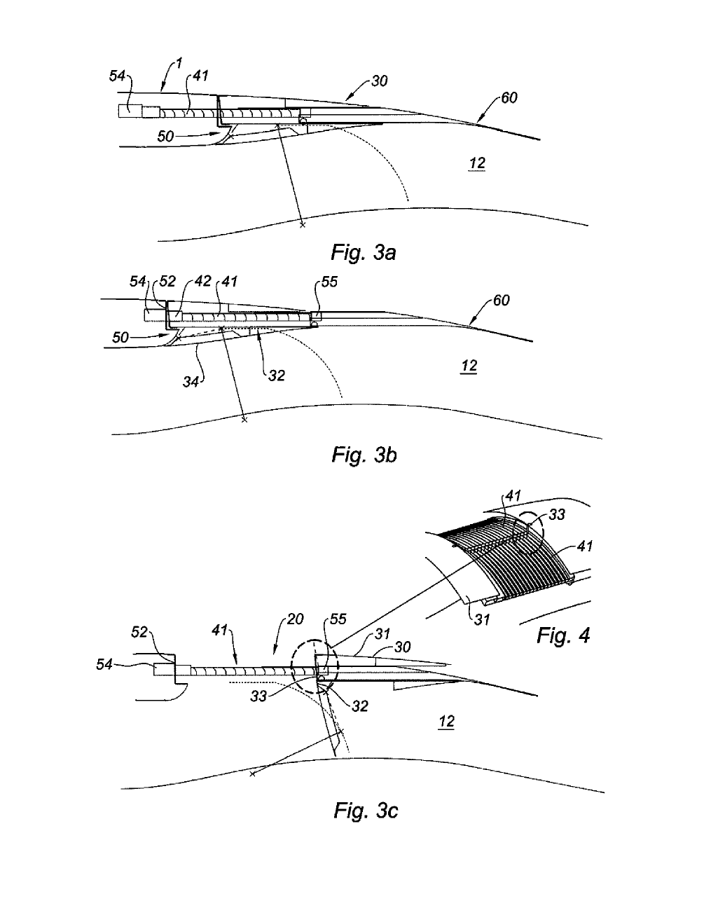

In reference to FIGS. 3a, 3b and 3c, the operating principle of the thrust reversal device 20 described is as follows.

In direct jet illustrated in FIG. 3a, the jet pipe nozzle 60 is in the cruising position, i.e. ensuring the aerodynamic continuity of the cowl 30, and the cowl 30 is in a closed position ensuring aerodynamic continuity with the middle section 1 of the nacelle.

The support element 54 and the cascade vanes 41 are in their extreme upstream position, i.e. maximally housed in the thickness of the middle section 1.

When varying the cross-section of the jet pipe nozzle 60 as illustrated in FIG. 3b, and more particularly when the cross-section of the jet pipe nozzle 60 is increased, the jet pipe nozzle 60 is translated downstream, causing an increase in the outlet cross-section.

At the same time, the support element 54, the vanes 41 and the rear frame 55 also move in the downstream direction, until the support element 54 comes into contact with the fittings 52 of the front stationary part of the front frame 50, the extension structure 42 of the vanes 41 making it possible to position that support element 54 immediately upstream of the fittings 52 passing through the vanes 41.

The reverser flaps 34 retain their position ensuring aerodynamic continuity of the inner cowl 32 with the fan cowl 3.

During thrust reversal, the first moving assembly is translated maximally downstream, in order to position the vanes 41 in their reverse jet positions, i.e. their position in which the support element 54 is immediately upstream of the fittings 52 passing through the vanes 41.

The cowl 30 is translated axially downstream of the nacelle into a position in which it uncovers the cascade vanes 41.

In that position, the fittings 33 connecting the inner shroud 32 and the outer shroud 31 of the cowl 30 are found immediately upstream of the rear frame 55 of the cascade vanes 41.

During translation of the cowl 30 in the downstream direction of the nacelle, the reverser flaps 34 are gradually deployed in the cold flow tunnel 12 in order to reorient the cold flow of the tunnel 12 toward the uncovered vanes 41 in the upstream direction of the nacelle.

In FIG. 3c, the cowl 30 is completely open and the thrust reverser device 20 is fully activated.

One alternative form of the present disclosure proposes establishing axial contact to react the forces of the outer shroud 31 by the front stationary portion of the front frame 50 using a set of stops, in order to transmit the axial forces undergone by the vanes 41 directly to the stationary part of the front frame 50 without passing through the jacks 80.

The invention is of course not limited solely to the various forms of the nacelle and methods described above as examples, but on the contrary encompasses all alternatives thereof.

What is claimed is:

1. A bypass turbojet engine nacelle equipped with a thrust reverser device, comprising:
a cowl;
a diversion means supported by a front frame upstream of the cowl,
said cowl having translational mobility in a direction substantially parallel to a longitudinal axis of the nacelle and being able alternately to move from a closed position in which the cowl provides aerodynamic continuity of the nacelle and covers the diversion means, into an open position in which the cowl opens up a passage in the nacelle and uncovers the diversion means;
a variable-geometry jet pipe nozzle mounted at a downstream end of said cowl, said jet pipe nozzle being translatable in a direction substantially parallel to a longitudinal axis of the nacelle towards at least one position that causes a variation in the jet pipe nozzle cross-section, characterized in that at least part of the front frame, the diversion means, and the jet pipe nozzle form an assembly having translational mobility in a direction substantially parallel to a longitudinal axis of the nacelle in a downstream direction of the nacelle towards a position that causes a variation in the cross-section of the jet pipe nozzle, the cowl being in the closed position during movement of said assembly.

2. The nacelle according to claim 1, characterized in that the front frame comprises a support element for the diversion means, said support element being translatable with the jet pipe nozzle when the jet pipe nozzle is moved toward a position causing a variation in the cross-section of the jet pipe nozzle.

3. The nacelle according to claim 1, characterized in that the diversion means are extended downstream by a rear frame secured to the jet pipe nozzle, said rear frame being translatable with the jet pipe nozzle when the jet pipe nozzle is moved toward a position causing a variation in the section of the jet pipe nozzle.

4. The nacelle according to claim 1, characterized in that the jet pipe nozzle is suitable for sliding inside the cowl.

5. The nacelle according to claim 4, characterized in that the jet pipe nozzle comprises first and second covering panels providing a covering between the jet pipe nozzle and an outer shroud and an inner shroud of the cowl, respectively.

6. The nacelle according to claim 5, characterized in that a rail-guideway assembly is formed between the first covering panel of the jet pipe nozzle and the outer shroud of the cowl.

7. The nacelle according to claim 2, characterized in that the nacelle also comprises a middle section upstream of the thrust reverser device, at least the support element of the front frame and at least part of the diversion means being housed in said middle section.

8. The nacelle according to claim 1, characterized in that the diversion means comprises cascade vanes and an upstream extension structure of said vanes being suitable for ensuring limited downstream movement of the front frame.

9. The nacelle according to claim 7, characterized in that the front frame comprises a front stationary part having discrete fittings to support the middle section of the nacelle.

10. The nacelle according to claim 7, characterized in that the front frame comprises a support surface sliding between the middle section and the front frame.

11. The nacelle according to claim 1, characterized in that the nacelle also comprises means for actuating the cowl placed between two reverser flaps, under a surface producing a pressure barrier for cold air tunnels.

12. The nacelle according to claim 8, characterized in that the nacelle also comprises means for actuating the jet pipe nozzle, cascade vanes, and at least part of the front frame placed between two adjacent cascade vanes.

13. A method for varying a cross-section of a jet pipe nozzle of a nacelle implemented with the nacelle according to claim 1 in which part of the front frame, the diversion means, and the jet pipe nozzle forming an assembly are translated in a direction substantially parallel to a longitudinal axis of the nacelle in the downstream direction of the nacelle toward a position causing a variation in the cross-section of the jet pipe nozzle, the cowl being in its closed position during the movement of said assembly.
